(19) United States
(12) Patent Application Publication
(10) Pub. No.: US 2024/0265693 A1
(43) Pub. Date: Aug. 8, 2024

(54) IMAGE PROCESSING APPARATUS AND IMAGE PROCESSING SYSTEM

(71) Applicant: Hitachi Astemo, Ltd., Hitachinaka-shi, Ibaraki (JP)

(72) Inventors: Kota IRIE, Hitachinaka-shi, Ibaraki (JP); Hirotomo SAI, Hitachinaka-shi, Ibaraki (JP); Takakiyo YASUKAWA, Hitachinaka-shi, Ibaraki (JP)

(73) Assignee: Hitachi Astemo, Ltd., Hitachinaka-shi, Ibaraki (JP)

(21) Appl. No.: 18/565,413

(22) PCT Filed: Feb. 7, 2022
(86) PCT No.: PCT/JP2022/004663

§ 371 Date: Nov. 29, 2023

(30) Foreign Application Priority Data
Jul. 29, 2021 (JP) 2021-124063

(51) Int. Cl. G06V 10/70; G06V 10/94; G06V 20/56; G06V 20/58; H04N 17/00; H04N 23/90

(52) U.S. Cl. CPC G06V 10/87; G06V 10/94; G06V 20/58; H04N 17/002; G06V 20/588; G06V 2201/03; H04N 23/90

(57) ABSTRACT

Provided are an image processing apparatus and an image processing system capable of performing control in a state where redundancy is secured even when an imaging device itself has failed or is malfunctioning. The image processing apparatus 3 recognizes a recognition target based on image data obtained by imaging an outside world using a first imaging device 2a and a second imaging device 2b installed to be spaced apart from the first imaging device 2a in a vertical direction from an interior of a vehicle via a window glass 6, and includes: a first image processing unit 3a that recognizes a first recognition target based on image data of the first imaging device 2a; and a second image processing unit 3b that recognizes a second recognition target different from the first recognition target based on image data of the first imaging device 2a and the second imaging device 2b. When a predetermined condition is satisfied, the second image processing unit 3b recognizes the first recognition target.

### TECHNICAL FIELD

The present invention relates to an image processing apparatus and an image processing system, and particularly relates to an image processing apparatus and an image processing system suitable for being mounted on a vehicle.

### BACKGROUND ART

In recent years, there has been a great increase in interest in automobile safety technologies. In response thereto, various preventive safety systems have been put into practical use mainly by automobile-related companies and the like.

For example, PTL 1 discloses a technique including an outdoor camera and an indoor camera that are installed to be spaced apart from each other in a vertical direction, and an image processing apparatus, in which a first image of the outdoor camera and a second image of the indoor camera are received, an imaging range of the second image including at least a partial portion of an imaging range of the first image, and an abnormality of the first image or the second image is determined based on a common portion in the imaging range between the first image and the second image. In the technique disclosed in PTL 1, when an abnormality occurs in any one of the outdoor camera and the indoor camera, adhesion of foreign matters or fogging, which is an abnormality, is removed.

### CITATION LIST

### Patent Literature

PTL 1: JP 2019-125942 A

### SUMMARY OF INVENTION

### Technical Problem

However, in the technique disclosed in PTL 1, no consideration is given to performing control in a state where redundancy is maintained when the outdoor camera or the indoor camera (imaging device) itself has failed or is malfunctioning.

Therefore, the present invention provides an image processing apparatus and an image processing system capable of performing control in a state where redundancy is secured even when an imaging device itself has failed or is malfunctioning.

### Solution to Problem

In order to solve the aforementioned problem, the image processing apparatus according to the present invention is an image processing apparatus that recognizes a recognition target based on image data obtained by imaging an outside world using a first imaging device and a second imaging device installed to be spaced apart from the first imaging device in a vertical direction from an interior of a vehicle via a window glass, the image processing apparatus including: a first image processing unit that recognizes a first recognition target based on image data of the first imaging device; and a second image processing unit that recognizes a second recognition target different from the first recognition target based on image data of the first imaging device and the second imaging device, in which when a predetermined condition is satisfied, the second image processing unit recognizes the first recognition target.

In addition, the image processing system according to the present invention is an image processing system that images an outside world from an interior of a vehicle via a window glass to recognize a recognition target, the image processing system including: a first imaging device; a second imaging device installed to be spaced apart from the first imaging device in a vertical direction; a first image processing unit electrically connected to at least the first imaging device; and a second image processing unit electrically connected to the first imaging device and the second imaging device, in which the first image processing unit recognizes a first recognition target based on image data of the first imaging device, the second image processing unit recognizes a second recognition target different from the first recognition target based on image data of the first imaging device and the second imaging device, and when a predetermined condition is satisfied, the second image processing unit recognizes the first recognition target.

### Advantageous Effects of Invention

According to the present invention, it is possible to provide an image processing apparatus and an image processing system capable of performing control in a state where redundancy is secured even when the imaging device itself has failed or is malfunctioning.

Other problems, configurations, and effects that are not described above will be apparent from the following description of embodiments.

### BRIEF DESCRIPTION OF DRAWINGS

FIG. 1 illustrates a front view and a side view of a vehicle equipped with an image processing system according to an embodiment of the present invention.

FIG. 2 is an overall schematic configuration diagram of an image processing system according to a first embodiment of the present invention.

FIG. 3 is a functional block diagram of an image processing apparatus constituting the image processing system according to the first embodiment.

FIG. 4 is an overhead view illustrating an example of a case where a vehicle equipped with the image processing system according to the first embodiment is present at an intersection with a traffic light.

FIG. 5 is a flowchart illustrating a flow of performed by the image processing apparatus a process constituting the image processing system according to the first embodiment.

FIG. 6 is a flowchart illustrating a flow of another process performed by the image processing apparatus according to the first embodiment.

FIG. 7 is an overall schematic configuration diagram illustrating a modification of the image processing system according to the first embodiment.

FIG. 8 is a functional block diagram of the image processing apparatus illustrated in FIG. 7.

FIG. 9 is a diagram illustrating an example of a wiper position in a degeneration mode according to a second embodiment of the present invention.

FIG. 10 is a diagram illustrating another example of a wiper position in the degeneration mode according to the second embodiment.

FIG. 11 is a diagram illustrating another example of a wiper position in the degeneration mode according to the second embodiment.

FIG. 12 is a diagram illustrating a wiper position in a normal mode.

### DESCRIPTION OF EMBODIMENTS

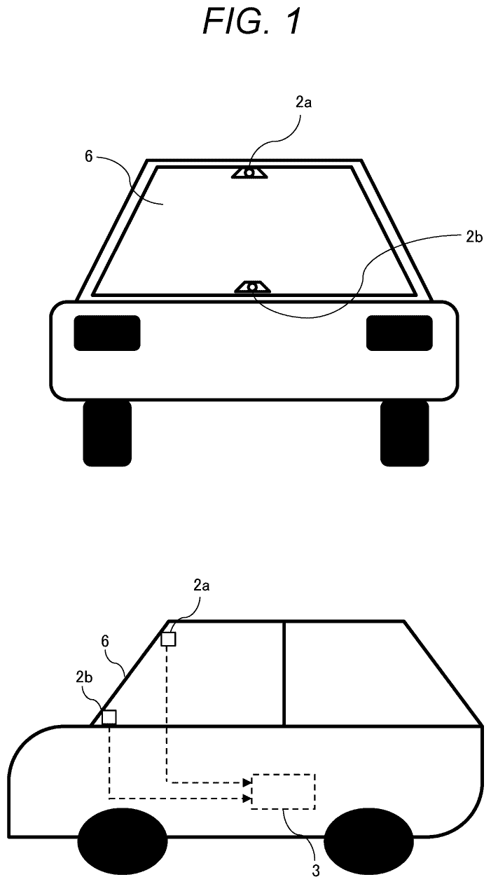

FIG. 1 illustrates a front view and a side view of a vehicle equipped with an image processing system according to an embodiment of the present invention. As illustrated in the side view of FIG. 1, the image processing system according to the present invention includes a first imaging device 2a installed at an upper portion of a window glass (windshield) 6, a second imaging device 2b installed at a lower portion of the window glass (windshield) 6, and an image processing apparatus 3. As illustrated in the front view of FIG. 1, the second imaging device 2b is installed to be spaced apart from the first imaging device 2a in a vertical direction. Here, it is preferable that a field of view (FOV) of the second imaging device 2b is narrower than a field of view (FOV) of the first imaging device 2a. This is because the second imaging device 2b can easily recognize a farther object (image a farther object). However, the present invention is not limited thereto, and the FOV of the first imaging device 2a and the FOV of the second imaging device 2b may be the same. The first imaging device 2a and the second imaging device 2b are realized by, for example, cameras, charge coupled devices (CCDs), image sensors, or the like. Furthermore, as illustrated in the side view of FIG. 1, the first imaging device 2a and the second imaging device 2b are electrically connected to the image processing apparatus 3 via respective signal lines. Note that the signal lines may be wired lines or wireless lines.

Hereinafter, embodiments of the present invention will be described with reference to the drawings.

### First Embodiment

### [Configuration of Image Processing System 1]

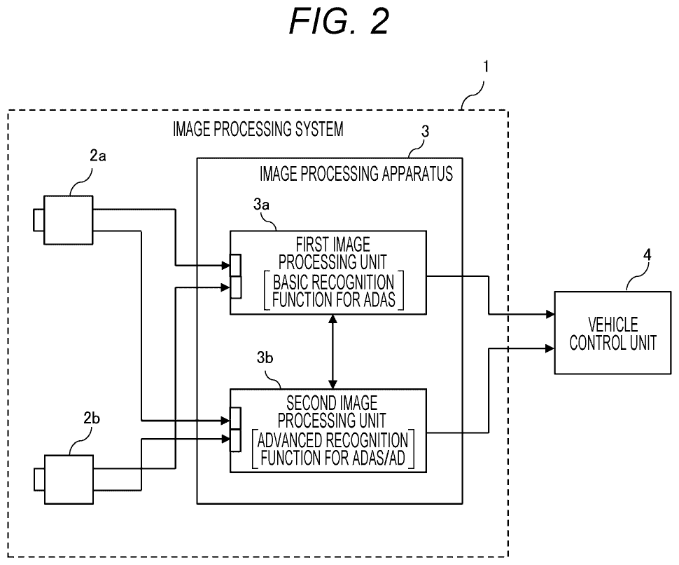

FIG. 2 is an overall schematic configuration diagram of an image processing system according to a first embodiment of the present invention. As illustrated in FIG. 2, the image processing system 1 includes a first imaging device 2a, a second imaging device 2b, and an image processing apparatus 3. The image processing apparatus 3 includes a first image processing unit 3a having a basic recognition function for an advanced driver-assistance system (ADAS), and a second image processing unit 3b having an advanced recognition function for an ADAS/automated driving system (ADS, hereinafter referred to as AD). The first imaging device 2a is electrically connected to the first image processing unit 3a and the second image processing unit 3b constituting the image processing apparatus 3 via signal lines. Similarly, the second imaging g device 2b is electrically connected to the first image processing unit 3a and the second image processing unit 3b constituting the image processing apparatus 3 via signal lines. An output of the first image processing unit 3a constituting the image processing apparatus 3 and an output of the second image processing unit 3b constituting the image processing apparatus 3 are input to a vehicle control unit 4. As will be described in detail later, the first image processing unit 3a and the second image processing unit 3b are configured to be able to communicate with each other.

### [Configuration of Image Processing Apparatus 3]

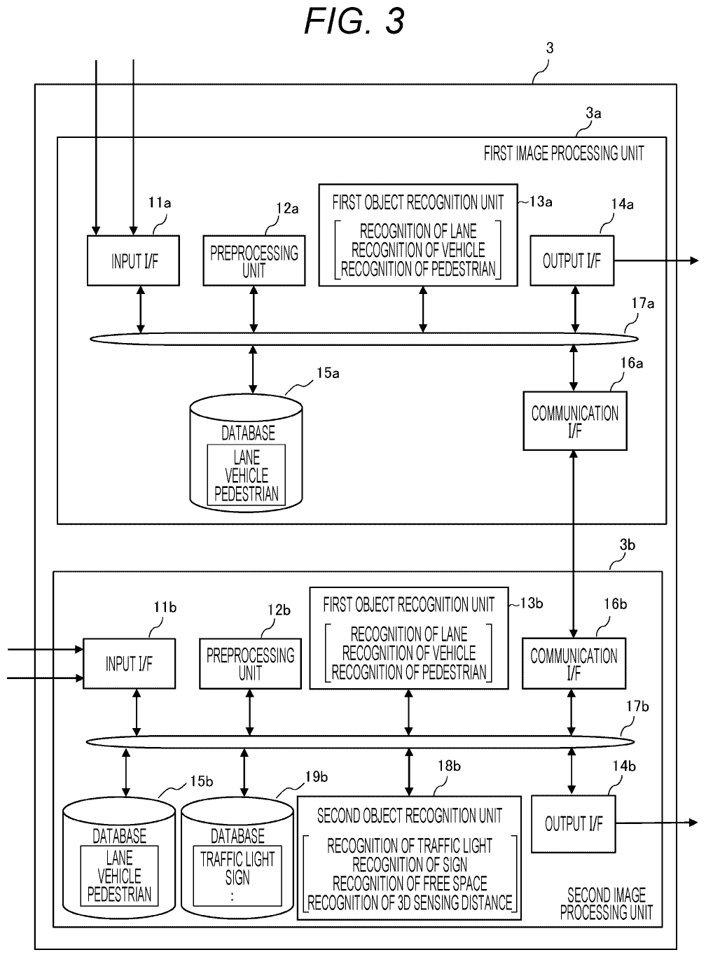

FIG. 3 is a functional block diagram of the image processing apparatus 3 constituting the image processing system 1 according to the present embodiment. As illustrated in FIG. 3, the first image processing unit 3a constituting the image processing apparatus 3 includes an input I/F 11a, a preprocessing unit 12a, a first object recognition unit 13a, an output I/F 14a, a database 15a, and a communication I/F 16a, which can communicate with (transfer data to) each other via an internal bus 17a. Here, the preprocessing unit 12a and the first object recognition unit 13a are realized by, for example, a processor such as a CPU (not illustrated), a ROM that stores various programs, a RAM that temporarily stores data in a calculation process, and a storage device such as an external storage device, and the processor such as the CPU reads and executes the various programs stored in the ROM and stores calculation results that are execution results in the RAM or the external storage device. For example, the first image processing unit 3a is preferably mounted on one electronic control unit (ECU).

The input I/F 11a acquires image data of 30 frames or 60 frames per second from the first imaging device 2a and the second imaging device 2b. Note that the number of frames per second is not limited thereto. When the input I/F 11a acquires no image data from the first imaging device 2a, it can be determined that the first imaging device 2a has failed. Similarly, when the input I/F 11a acquires no image data from the second imaging device 2b, it can be determined that the second imaging device 2b has failed. The input I/F 11a transfers the image data acquired from the first imaging device 2a to the preprocessing unit 12a via the internal bus 17a.

For example, the preprocessing unit 12a performs contour enhancement processing, smoothing processing, normalization processing, or the like on the image data of the first imaging device 2a transferred from the input I/F 11a. Since the image data of the first imaging device 2a varies in luminance depending on an imaging time zone, weather, or the like, the normalization processing is effective. Note that, when the luminance of the image data of the first imaging device 2a is obviously abnormal and it is difficult for the preprocessing unit 12a to perform normalization processing on the image data of the first imaging device 2a, it can be determined that the first imaging device 2a has failed. The preprocessing unit 12a transfers the preprocessed image data to the first object recognition unit 13a via the internal bus 17a.

The first object recognition unit 13a recognizes a first recognition target from the preprocessed image data transferred from the preprocessing unit 12a using a convolution neural network (CNN) such as U-Net. Here, the first recognition target is, for example, a lane, a vehicle, a two-wheeled vehicle, a pedestrian, or the like. When the first recognition target is recognized from the preprocessed image data, the configuration is not limited to the use of the CNN, and for example, template matching processing may be executed using data stored in the database 15a, which will be described later. The first object recognition unit 13a outputs a lane recognition result, a vehicle recognition result, a two-wheeled vehicle recognition result, a pedestrian recognition result, or the like as a result of recognizing the first recognition target to the vehicle control unit 4 via the internal bus 17a and the output I/F 14a for use in executing the ADAS function.

Data on the lane, the vehicle, the two-wheeled vehicle, the pedestrian, and the like is stored in the database 15a in advance.

Furthermore, as illustrated in FIG. 3, the second image processing unit 3b constituting the image processing apparatus 3 includes an input I/F 11b, a preprocessing unit 12b, a first object recognition unit 13b, an output I/F 14b, a database 15b, a communication I/F 16b, a second object recognition unit 18b, and a database 19b, which can communicate with (transfer data to) each other via an internal bus 17b. Here, the preprocessing unit 12b, the first object recognition unit 13b, and the second object recognition unit 18b are realized by, for example, a processor such as a CPU (not illustrated), a ROM that stores various programs, a RAM that temporarily stores data in a calculation process, and a storage device such as an external storage device, and the processor such as the CPU reads and executes the various programs stored in the ROM and stores calculation results that are execution results in the RAM or the external storage device. For example, the second image processing unit 3b is preferably mounted on one ECU.

The input I/F 11b acquires image data of 30 frames or 60 frames per second from the first imaging device 2a and the second imaging device 2b. Note that the number of frames per second is not limited thereto. When the input I/F 11b acquires no image data from the first imaging device 2a, it can be determined that the first imaging device 2a has failed. Similarly, when the input I/F 11a acquires no image data from the second imaging device 2b, it can be determined that the second imaging device 2b has failed. The input I/F 11b transfers the image data acquired from the first imaging device 2a and the second imaging device 2b to the preprocessing unit 12b via the internal bus 17b.

For example, the preprocessing unit 12b performs contour enhancement processing, smoothing processing, normalization processing, or the like on the image data of the first imaging device 2a and the image data of the second imaging device 2b transferred from the input I/F 11b. Since the image data of the first imaging device 2a and the second imaging device 2b varies in luminance depending on an imaging time zone, weather, or the like, the normalization processing is effective. Note that, when the luminance of the image data of the first imaging device 2a or the second imaging device 2b is obviously abnormal and it is difficult for the preprocessing unit 12b to perform normalization processing on the image data of the first imaging device 2a or the second imaging device 2b, it can be determined that the first imaging device 2a or the second imaging device 2b has failed. The preprocessing unit 12b transfers the image data of the first imaging device 2a, which is preprocessed image data, to the first object recognition unit 13b via the internal bus 17b. In addition, the preprocessing unit 12b transfers the image data of the second imaging device 2b, which is preprocessed image data, to the second object recognition unit 18b via the internal bus 17b. Since the first object recognition unit 13b is similar to the first object recognition unit 13a, the description thereof is omitted here. Note that the first object recognition unit 13b operates when the first imaging device 2a or the first image processing unit 3a fails, which will be described later.

The second object recognition unit 18b recognizes a second recognition target from the image data of the second imaging device 2b, which is preprocessed image data transferred from the preprocessing unit 12b, using a convolution neural network (CNN) such as U-Net. Here, the second recognition target includes, for example, any of a display state of a traffic light, a road sign, a free space, a 3D sensing distance, and the like. Here, the free space refers to an area where an own vehicle is allowed to move. In other words, the free space refers to an area where there is no obstacle when the own vehicle moves. Furthermore, the 3D sensing distance is a distance between a target object (e.g., a traffic light or the like) and the own vehicle that can be measured more accurately by stereoscopic observation for obtaining three-dimensional information using the first imaging device 2a and the second imaging device 2b. When the second recognition target is recognized from the preprocessed image data, the configuration is not limited to the use of the CNN, and for example, template matching processing may be executed using data stored in the database 19b, which will be described later. The second object recognition unit 18b outputs a traffic light recognition result, a road sign recognition result, a free space recognition result, a 3D sensing distance recognition result, or the like as a result of recognizing the second recognition target to the vehicle control unit 4 via the internal bus 17b and the output I/F 14b for use in executing the advanced ADAS/AD function.

The database 19b stores in advance data necessary for recognizing a display state of a traffic light, a road sign, a free space, a 3D sensing distance, and the like.

The communication I/F 16b transmits and receives a monitoring signal at a predetermined cycle to and from, for example, the communication I/F 16a constituting the above-described first image processing unit 3a, and detects an abnormality of the counterpart. That is, when no response signal is transmitted from the communication I/F 16a constituting the first image processing unit 3a even though a monitoring signal is transmitted from the communication I/F 16b constituting the second image processing unit 3b to the communication I/F 16a constituting the first image processing unit 3a, it is determined that the first image processing unit 3a has failed. On the other hand, when no response signal is transmitted from the communication I/F 16b constituting the second image processing unit 3b even though a monitoring signal is transmitted from the communication I/F 16a constituting the first image processing unit 3a to the communication I/F 16b constituting the second image processing unit 3b, it is determined that the second image processing unit 3b has failed.

Note that, although the case where monitoring signals are transmitted and received between the first image processing unit 3a and the second image processing unit 3b has been described as an example in the present embodiment, but the present invention is not limited thereto. For example, the vehicle control unit 4 may be configured to transmit monitoring signals to the first image processing unit 3a and the second image processing unit 3b, and determine whether the first image processing unit 3a or the second image processing unit 3b has failed depending on whether response signals are received from the first image processing unit 3a and the second image processing unit 3b.

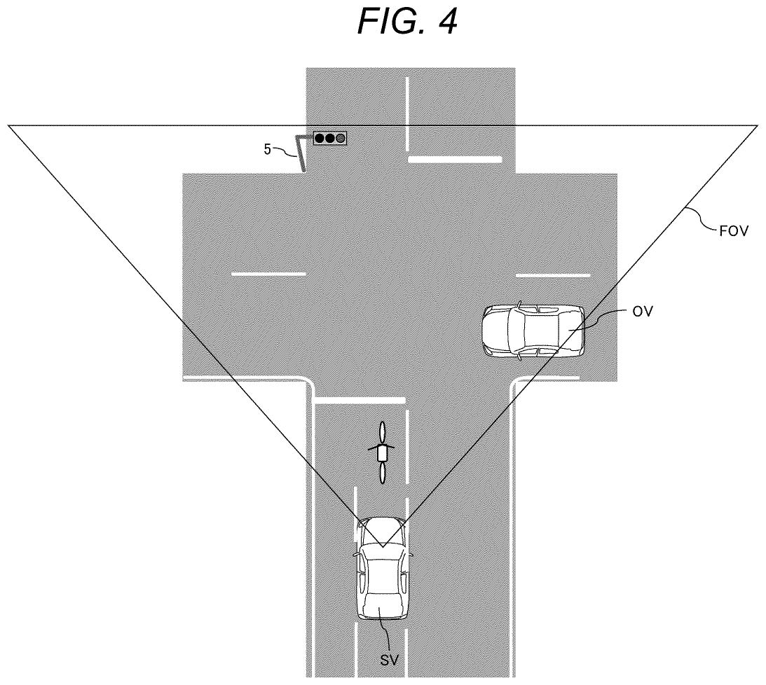

FIG. 4 is an overhead view illustrating an example of a case where a vehicle equipped with the image processing system 1 according to the present embodiment is present at an intersection with a traffic light. FIG. 4 illustrates a situation in which an own vehicle SV equipped with the image processing system 1 according to the present embodiment stops before an intersection because a display state of a traffic light 5 is “red”. In the example illustrated in FIG. 4, the FOV of the first imaging device 2a and the FOV of the second imaging device 2b are the same, and within the FOV, a two-wheeled vehicle, which is a first recognition target, stops in front of the own vehicle SV in the same lane (first recognition target) as the own vehicle SV, and another vehicle OV, which is a first recognition target, enters the intersection from the right side. In addition, the traffic light 5, which is a second recognition target, is present within the FOV. As represented by the traffic light 5, the second recognition target is an object having a predetermined height from the road surface, and for example, 3 m or 5 m is set as the predetermined height. Here, 3 m corresponds to a height of a road sign (not illustrated), which is a second recognition target, and 5 m corresponds to the height of the traffic light 5. However, the predetermined height is not limited to 3 m or 5 m.

### [Flow of Process of Image Processing Apparatus 3]

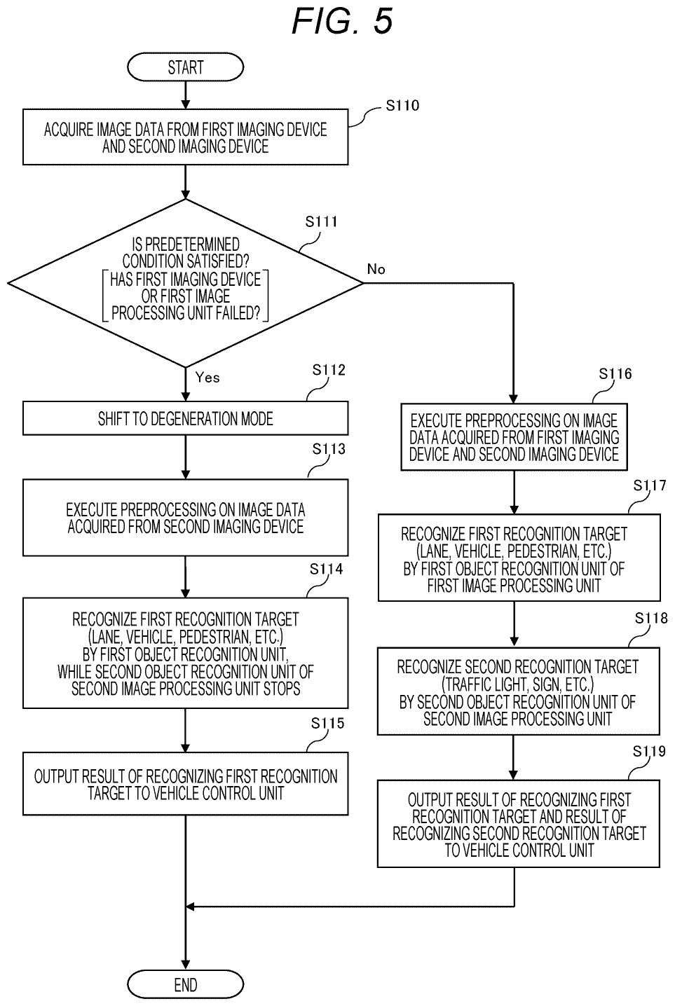

Next, specific processing operations of the image processing apparatus 3 according to the present embodiment will be described below. FIG. 5 is a flowchart illustrating a flow of a process performed by the image processing apparatus 3 constituting the image processing system 1 according to the present embodiment.

In step S110, the input I/F 11a of the first image processing unit 3a and the input I/F 11b of the second image processing unit 3b constituting the image processing apparatus 3 acquire image data from the first imaging device 2a and the second imaging device 2b.

In step S111, it is determined whether a predetermined condition is satisfied, that is, whether the first imaging device 2a or the first image processing unit 3a has failed. As described above, whether the first imaging device 2a has failed is determined by the input I/F 11a and the preprocessing unit 12a constituting the first image processing unit 3a or the input I/F 11b and the preprocessing unit 12b constituting the second image processing unit 3b. In addition, whether the first image processing unit 3a has failed is determined by the communication I/F 16b constituting the second image processing unit 3b or the vehicle control unit 4 as described above. When the determination result satisfies the predetermined condition, the process proceeds to step S112. On the other hand, when the determination result does not satisfy the predetermined condition, the process proceeds to step S116.

In step S112, the mode shifts to a degeneration mode. Then, in step S113, the preprocessing unit 12b constituting the second image processing unit 3b executes the above-described preprocessing on the image data acquired from the second imaging device 2b, and transfers the preprocessed image data to the first object recognition unit 13b via the internal bus 17b.

Next, in step S114, the second object recognition unit 18b constituting the second image processing unit 3b stops, and the first object recognition unit 13b recognizes a lane, a vehicle, a two-wheeled vehicle, a pedestrian, or the like, which is a first recognition target.

In step S115, the first object recognition unit 13b constituting the second image processing unit 3b outputs a lane recognition result, a vehicle recognition result, a two-wheeled vehicle recognition result, a pedestrian recognition result, or the like as a result of recognizing the first recognition target to the vehicle control unit 4 via the internal bus 17b and the output I/F 14b. As a result, although the execution of the advanced ADAS/AD function is stopped, the output recognition result is used to execute the ADAS function. That is, redundancy is ensured.

On the other hand, in step S116, the preprocessing unit 12a constituting the first image processing unit 3a and the preprocessing unit 12b constituting the second image processing unit 3b execute the above-described preprocessing on the image data acquired from the first imaging device 2a and the second imaging device 2b.

In step S117, the first object recognition unit 13a constituting the first image processing unit 3a recognizes a first recognition target. That is, a lane, a vehicle, a two-wheeled vehicle, a pedestrian, or the like, which is a first recognition target, is recognized.

In step S118, the second object recognition unit 18b constituting the second image processing unit 3b recognizes a second recognition target. That is, a display state of a traffic light, a road sign, a free space, a 3D sensing distance, or the like, which is a second recognition target, is recognized.

In step S119, the first object recognition unit 13a constituting the first image processing unit 3a outputs a lane recognition result, a vehicle recognition result, a two-wheeled vehicle recognition result, a pedestrian recognition result, or the like as a result of recognizing the first recognition target to the vehicle control unit 4 via the internal bus 17a and the output I/F 14a. In addition, the second object recognition unit 18b constituting the second image processing unit 3b outputs a traffic light recognition result, a road sign recognition result, a free space recognition result, a 3D sensing distance recognition result, or the like as a result of recognizing the second recognition target to the vehicle control unit 4 via the internal bus 17b and the output I/F 14b. As a result, the output recognition result is used execute the advanced ADAS/AD function and the ADAS function.

In the present embodiment, step S118 is executed after step S117, but the present invention is not limited thereto, and step S117 and step S118 may be executed in parallel.

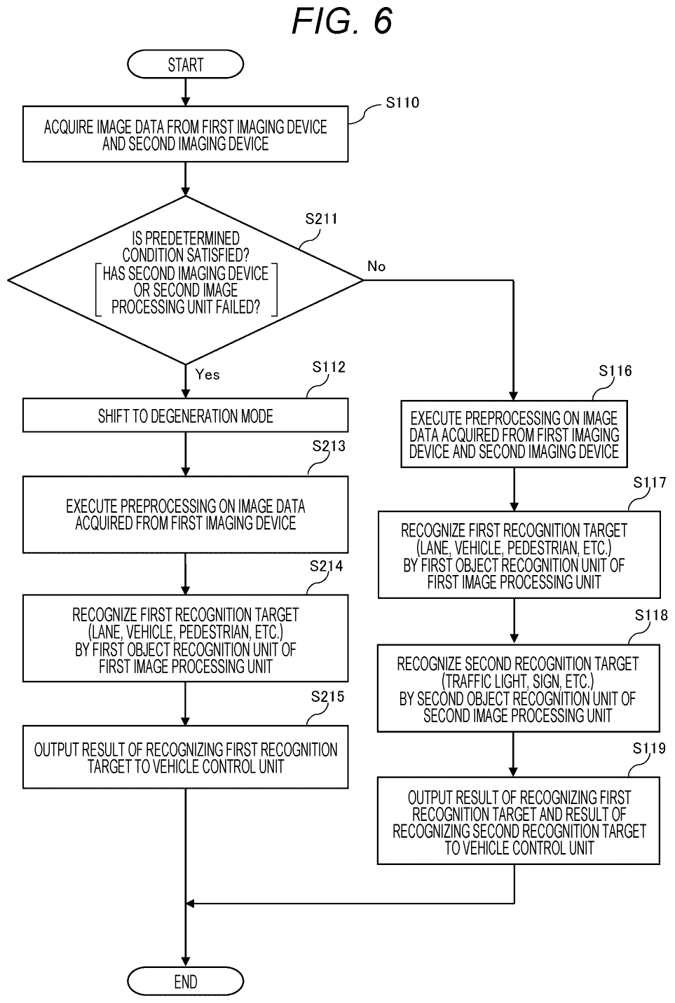

FIG. 6 is a flowchart illustrating a flow of another process performed by the image processing apparatus 3 according to the present embodiment. As illustrated in FIG. 6, in step S110, the input I/F 11a of the first image processing unit 3a and the input I/F 11b of the second image processing unit 3b constituting the image processing apparatus 3 acquire image data from the first imaging device 2a and the second imaging device 2b.

In step S211, it is determined whether a predetermined condition is satisfied, that is, whether the second imaging device 2b or the second image processing unit 3b has failed. As described above, whether the second imaging device 2b has failed is determined by the input I/F 11a and the preprocessing unit 12a constituting the first image processing unit 3a or the input I/F 11b and the preprocessing unit 12b constituting the second image processing unit 3b. In addition, whether the second image processing unit 3b has failed is determined by the communication I/F 16a constituting the first image processing unit 3a or the vehicle control unit 4 as described above. When the determination result satisfies the predetermined condition, the process proceeds to step S112. On the other hand, when the determination result does not satisfy the predetermined condition, the process proceeds to step S116.

In step S112, the mode shifts to a degeneration mode. Then, in step S213, the preprocessing unit 12a constituting the first image processing unit 3a executes the above-described preprocessing on the image data acquired from the first imaging device 2a, and transfers the preprocessed image data to the first object recognition unit 13a via the internal bus 17a.

Next, in step S214, the first object recognition unit 13a constituting the first image processing unit 3a recognizes a lane, a vehicle, a two-wheeled vehicle, a pedestrian, or the like, which is a first recognition target.

In step S215, the first object recognition unit 13a constituting the first image processing unit 3a outputs a lane recognition result, a vehicle recognition result, a two-wheeled vehicle recognition result, a pedestrian recognition result, or the like as a result of recognizing the first recognition target to the vehicle control unit 4 via the internal bus 17a and the output I/F 14a. As a result, although the execution of the advanced ADAS/AD function is stopped, the output recognition result is used to execute the ADAS function. That is, redundancy is ensured.

On the other hand, in step S116, the preprocessing unit 12a constituting the first image processing unit 3a and the preprocessing unit 12b constituting the second image processing unit 3b execute the above-described preprocessing on the image data acquired from the first imaging device 2a and the second imaging device 2b.

In step S117, the first object recognition unit 13a constituting the first image processing unit 3a recognizes a first recognition target. That is, a lane, a vehicle, a two-wheeled vehicle, a pedestrian, or the like, which is a first recognition target, is recognized.

In step S118, the second object recognition unit 18b constituting the second image processing unit 3b recognizes a second recognition target. That is, a display state of a traffic light, a road sign, a free space, a 3D sensing distance, or the like, which is a second recognition target, is recognized.

In step S119, the first object recognition unit 13a constituting the first image processing unit 3a outputs a lane recognition result, a vehicle recognition result, a two-wheeled vehicle recognition result, a pedestrian recognition result, or the like as a result of recognizing the first recognition target to the vehicle control unit 4 via the internal bus 17a and the output I/F 14a. In addition, the second object recognition unit 18b constituting the second image processing unit 3b outputs a traffic light recognition result, a road sign recognition result, a free space recognition result, a 3D sensing distance recognition result, or the like as a result of recognizing the second recognition target to the vehicle control unit 4 via the internal bus 17b and the output I/F 14b. As a result, the output recognition result is used execute the advanced ADAS/AD function and the ADAS function.

In the present embodiment, step S118 is executed after step S117, but the present invention is not limited thereto, and step S117 and step S118 may be executed in parallel.

### <Modification of Image Processing System>

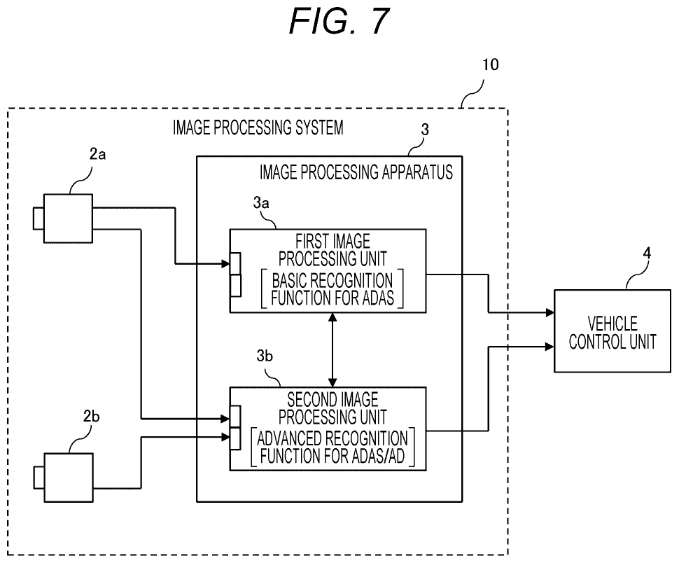

FIG. 7 is an overall schematic configuration diagram illustrating a modification of the image processing system according to the present embodiment. As illustrated in FIG. 7, an image processing system 10 includes a first imaging device 2a, a second imaging device 2b, and an image processing apparatus 3. The image processing apparatus 3 includes a first image processing unit 3a having a basic recognition function for ADAS and a second image processing unit 3b having an advanced recognition function for ADAS/ADS. The first imaging device 2a is electrically connected to the first image processing unit 3a and the second image processing unit 3b constituting the image processing apparatus 3 via signal lines. On the other hand, the second imaging device 2b is electrically connected only to the second image processing unit 3b constituting the image processing apparatus 3 via a signal line. At this point, the image processing system 10 is different from the above-described image processing system 1 illustrated in FIG. 2. An output of the first image processing unit 3a constituting the image processing apparatus 3 and an output of the second image processing unit 3b constituting the image processing apparatus 3 are input to a vehicle control unit 4.

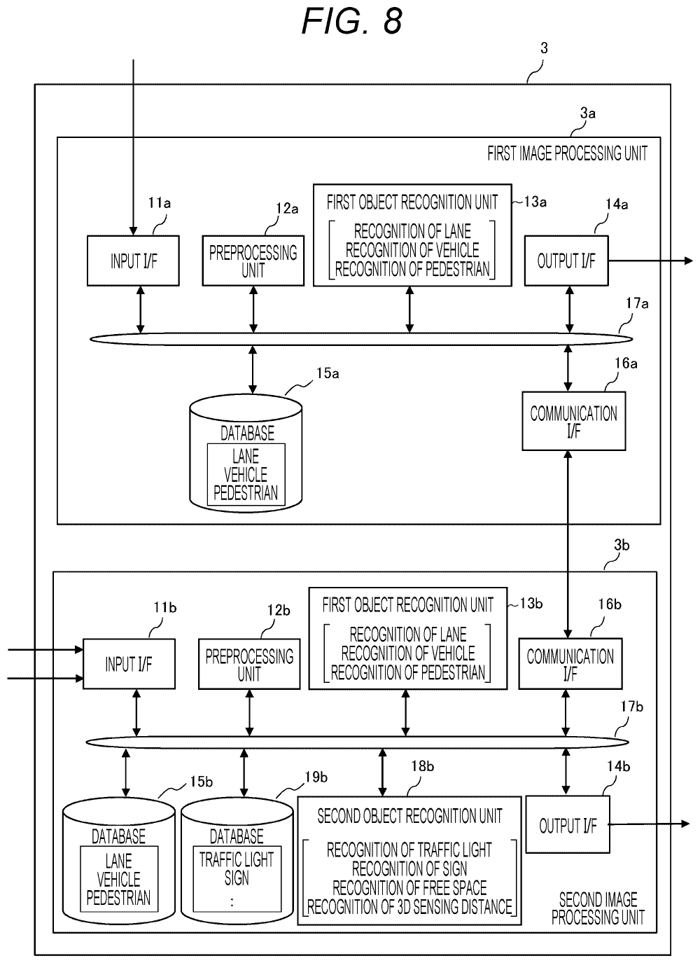

FIG. 8 is a functional block diagram of the image processing apparatus 3 illustrated in FIG. 7. As illustrated in FIG. 8, the first image processing unit 3a constituting the image processing apparatus 3 includes an input I/F 11a, a preprocessing unit 12a, a first object recognition unit 13a, an output I/F 14a, a database 15a, and a communication I/F 16a, which can communicate with (transfer data to) each other via an internal bus 17a. Here, the preprocessing unit 12a and the first object recognition unit 13a are realized by, for example, a processor such as a CPU (not illustrated), a ROM that stores various programs, a RAM that temporarily stores data in a calculation process, and a storage device such as an external storage device, and the processor such as the CPU reads and executes the various programs stored in the ROM and stores calculation results that are execution results in the RAM or the external storage device. For example, the first image processing unit 3a is preferably mounted on one ECU.

The input I/F 11a acquires image data of 30 frames or 60 frames per second from the first imaging device 2a. Note that the number of frames per second is not limited thereto. When the input I/F 11a acquires no image data from the first imaging device 2a, it can be determined that the first imaging device 2a has failed. The input I/F 11a transfers the image data acquired from the first imaging device 2a to the preprocessing unit 12a via the internal bus 17a.

For example, the preprocessing unit 12a performs contour enhancement processing, smoothing processing, normalization processing, or the like on the image data of the first imaging device 2a transferred from the input I/F 11a. Since the image data of the first imaging device 2a varies in luminance depending on an imaging time zone, weather, or the like, the normalization processing is effective. Note that, when the luminance of the image data of the first imaging device 2a is obviously abnormal and it is difficult for the preprocessing unit 12a to perform normalization processing on the image data of the first imaging device 2a, it can be determined that the first imaging device 2a has failed. The preprocessing unit 12a transfers the preprocessed image data to the first object recognition unit 13a via the internal bus 17a.

The first object recognition unit 13a recognizes a first recognition target from the preprocessed image data transferred from the preprocessing unit 12a using a CNN such as U-Net. Here, the first recognition target is, for example, a lane, a vehicle, a two-wheeled vehicle, a pedestrian, or the like. When the first recognition target is recognized from the preprocessed image data, the configuration is not limited to the use of the CNN, and for example, template matching processing may be executed using data stored in the database 15a, which will be described later. The first object recognition unit 13a outputs a lane recognition result, a vehicle recognition result, a two-wheeled vehicle recognition result, a pedestrian recognition result, or the like as a result of recognizing the first recognition target to the vehicle control unit 4 via the internal bus 17a and the output I/F 14a for use in executing the ADAS function.

Data on the lane, the vehicle, the two-wheeled vehicle, the pedestrian, and the like is stored in the database 15a in advance.

Note that, since the second image processing unit 3b constituting the image processing apparatus 3 is similar to that in FIG. 3 described above, the description thereof is omitted.

Next, since the specific processing operations of the image processing apparatus 3 according to the present embodiment are substantially similar to those in FIGS. 5 and 6 described above, only different points will be described below.

In step S110 of FIG. 5, the input I/F 11a of the first image processing unit 3a constituting the image processing apparatus 3 acquires image data from the first imaging device 2a. Furthermore, the input I/F 11b of the second image processing unit 3b constituting the image processing apparatus 3 acquires image data from the first imaging device 2a and the second imaging device 2b.

In step S116 of FIG. 5, the preprocessing unit 12a constituting the first image processing unit 3a executes the above-described preprocessing on the image data acquired from the first imaging device 2a. In addition, the preprocessing unit 12b constituting the second image processing unit 3b executes the above-described preprocessing on the image data acquired from the first imaging device 2a and the second imaging device 2b.

In step S110 of FIG. 6, the input I/F 11a of the first image processing unit 3a constituting the image processing apparatus 3 acquires image data from the first imaging device 2a. Furthermore, the input I/F 11b of the second image processing unit 3b constituting the image processing apparatus 3 acquires image data from the first imaging device 2a and the second imaging device 2b.

In step S211 of FIG. 6, it is determined whether a predetermined condition is satisfied, that is, whether the second imaging device 2b or the second image processing unit 3b has failed. Whether the second imaging device 2b has failed is determined by the input I/F 11b and the preprocessing unit 12b constituting the second image processing unit 3b.

In step S116 of FIG. 6, the preprocessing unit 12a constituting the first image processing unit 3a executes the above-described preprocessing on the image data acquired from the first imaging device 2a. In addition, the preprocessing unit 12b constituting the second image processing unit 3b executes the above-described preprocessing on the image data acquired from the first imaging device 2a and the second imaging device 2b.

As described above, the modification is different from the above-described image processing system 1 in that only the second image processing unit 3b determines whether the second imaging device 2b has failed.

As described above, according to the present embodiment, it is possible to provide an image processing apparatus and an image processing system capable of performing control in a state where redundancy is secured even when the imaging device itself has failed or is malfunctioning.

### Second Embodiment

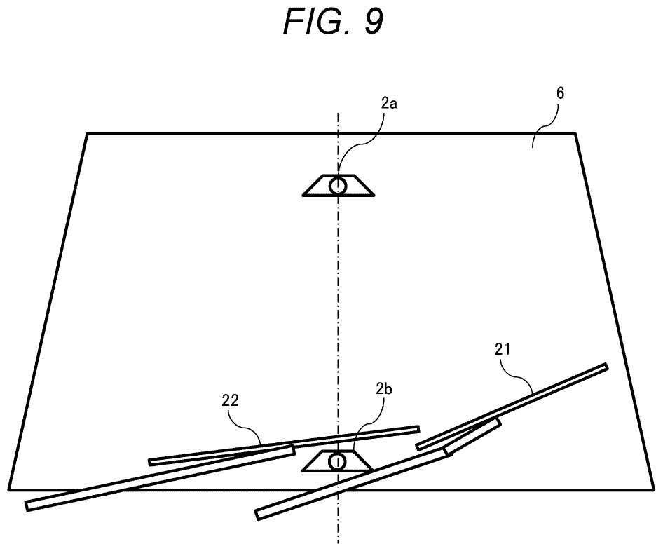

FIGS. 9 to 11 illustrate examples of wiper positions in the degeneration mode according to a second embodiment of the present invention. The present embodiment is different from the first embodiment described above in that, in addition to the first embodiment, a configuration is added in which a wiper is temporarily operated in the degeneration mode and stopped at a position not to obstruct the field of view (FOV) of the second imaging device 2b. Only the added point will be described below.

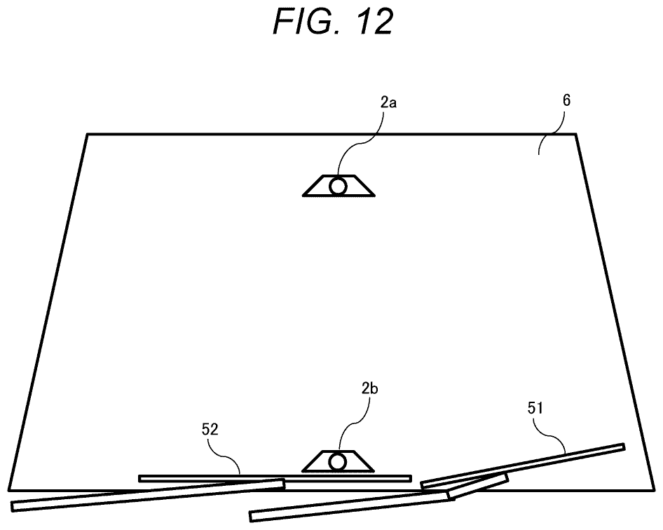

FIG. 12 is a diagram illustrating a wiper position in a normal mode. As illustrated in FIG. 12, there is a concern that a lower portion of the field of view (FOV) of the second imaging device 2b is hidden by a wiper L52. As described in the first embodiment above described, in the degeneration mode as the first imaging device 2a has failed, the image processing apparatus 3 needs to execute processing only based on the image data of the second imaging device 2b. For this reason, it is necessary to make the field of view (FOV) of the second imaging device 2b as wide as possible.

In the example illustrated in FIG. 9, a wiper R21 and a wiper L22 are driven by one actuator and motor. When the mode shifts to the degeneration mode in step S112 of FIGS. 5 and 6 in the first embodiment described above, the wiper R21 and the wiper L22 are temporarily operated in synchronization with each other, and the wiper R21 and the wiper L22 are stopped at positions to sandwich the second imaging device 2b therebetween so as not to obstruct the field of view (FOV) of the second imaging device 2b as illustrated in FIG. 9.

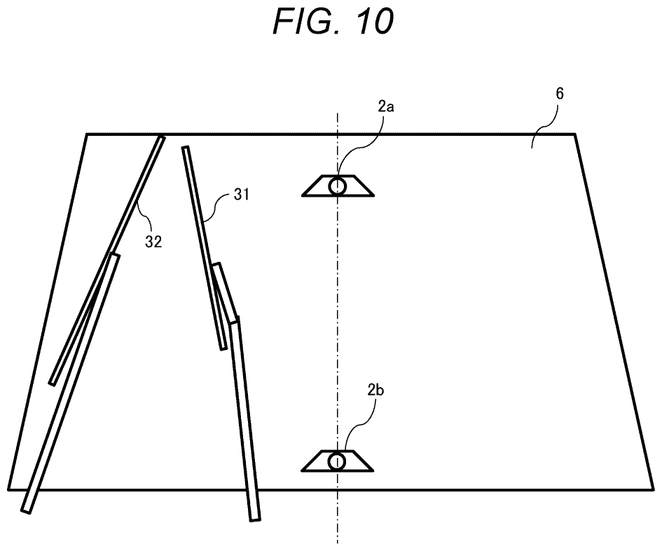

In the example illustrated in FIG. 10, a wiper R31 and a wiper L32 are driven by one actuator and motor. When the mode shifts to the degeneration mode in step S112 of FIGS. 5 and 6 in the first embodiment described above, the wiper R31 and the wiper L32 are temporarily operated in synchronization with each other, and the wiper R31 and the wiper L32 are stopped at positions where a reciprocating motion is turned back as illustrated in FIG. 9.

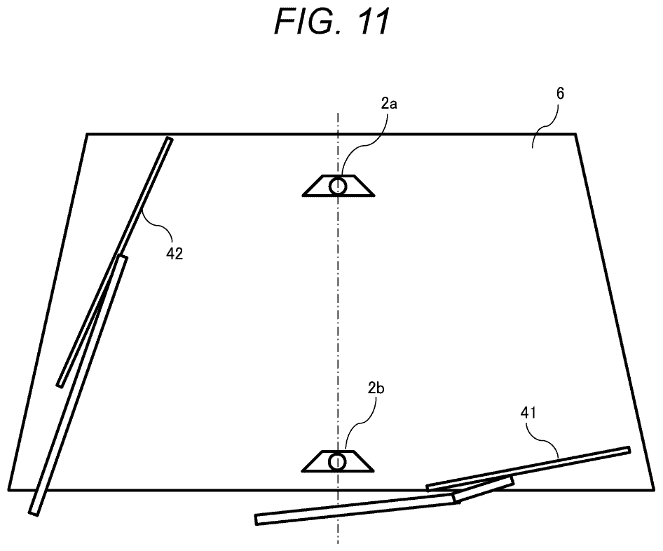

In the example illustrated in FIG. 11, since a motor is provided in each of a wiper R41 and a wiper L42, when the mode shifts to the degeneration mode, only the wiper L42, which is one of the wipers, is moved to a predetermined position and stopped at the predetermined position.

As described above, according to the present embodiment, in addition to the effect of the first embodiment, it is possible to reliably secure the imaging field of view of the second imaging device in the degeneration mode.

It should be noted that the present invention is not limited to the above-described embodiments, and includes various modifications. For example, the above-described embodiments have been described in detail in order to explain the present invention in an easy-to-understand manner, and are not necessarily limited to having all the configurations described above. In addition, a part of the configuration of one embodiment may be replaced with the configuration of another embodiment, and the configuration of one embodiment may be added to the configuration of another embodiment.

### REFERENCE SIGNS LIST

1, 10 image processing system
2a first imaging device
2b second imaging device
3 image processing apparatus
3a first image processing unit
3b second image processing unit
4 vehicle control unit
5 traffic light
6 window glass (windshield)
11a, 11b input I/F
12a, 12b preprocessing unit
13a, 13b first object recognition unit
14a, 14b output I/F
15a, 15b database
16a, 16b communication I/F
17a, 17b internal bus
18b second object recognition unit
19b database
21, 31, 41, 51 wiper R
22, 32, 42, 52 wiper L

1. An image processing apparatus that recognizes a recognition target based on image data obtained by imaging an outside world using a first imaging device and a second imaging device installed to be spaced apart from the first imaging device in a vertical direction from an interior of a vehicle via a window glass, the image processing apparatus comprising:
a first image processing unit that recognizes a first recognition target based on image data of the first imaging device; and
a second image processing unit that recognizes a second recognition target different from the first recognition target based on image data of the first imaging device and the second imaging device,
wherein when a predetermined condition is satisfied, the second image processing unit recognizes the first recognition target.

2. The image processing apparatus according to claim 1, wherein the predetermined condition is a failure of the first imaging device or a failure of the first image processing unit.

3. The image processing apparatus according to claim 2, wherein
the first image processing unit or the second image processing unit determines the failure of the first imaging device,
the second image processing unit determines the failure of the first image processing unit, and
when the predetermined condition is satisfied, the image processing apparatus shifts to a degeneration mode, and the second image processing unit recognizes the first recognition target.

4. The image processing apparatus according to claim 3, wherein when the predetermined condition is satisfied, the image processing apparatus shifts to the degeneration mode, and the second image processing unit recognizes the first recognition target based on image data of the second imaging device.

5. The image processing apparatus according to claim 3, wherein the second recognition target includes at least an object existing at a predetermined height or more from a road surface.

6. The image processing apparatus according to claim 5, wherein
the first recognition target includes a lane, a vehicle, a two-wheeled vehicle, and a pedestrian, and
the second recognition target includes any of a display state of a traffic light, a road sign, a free space that is an area where there is no obstacle when an own vehicle moves, and a 3D sensing distance.

7. The image processing apparatus according to claim 3, wherein when the predetermined condition is satisfied, the image processing apparatus shifts to the degeneration mode, and a wiper on the window glass is stopped at a position not to obstruct an imaging field of view of the second imaging device.

8. An image processing system that images an outside world from an interior of a vehicle via a window glass to recognize a recognition target, the image processing system comprising:
a first imaging device;
a second imaging device installed to be spaced apart from the first imaging device in a vertical direction;
a first image processing unit electrically connected to at least the first imaging device; and
a second image processing unit electrically connected to the first imaging device and the second imaging device,
wherein
the first image processing unit recognizes a first recognition target based on image data of the first imaging device,
the second image processing unit recognizes a second recognition target different from the first recognition target based on image data of the first imaging device and the second imaging device, and
when a predetermined condition is satisfied, the second image processing unit recognizes the first recognition target.

9. The image processing system according to claim 8, wherein the predetermined condition is a failure of the first imaging device or a failure of the first image processing unit.

10. The image processing system according to claim 9, wherein
the first image processing unit or the second image processing unit determines the failure of the first imaging device,
the second image processing unit determines the failure of the first image processing unit, and
when the predetermined condition is satisfied, the image processing system shifts to a degeneration mode, and the second image processing unit recognizes the first recognition target.

11. The image processing system according to claim 10, wherein when the predetermined condition is satisfied, the image processing system shifts to the degeneration mode, and the second image processing unit recognizes the first recognition target based on image data of the second imaging device.

12. The image processing system according to claim 10, wherein the second recognition target includes at least an object existing at a predetermined height or more from a road surface.

13. The image processing system according to claim 12, wherein
the first recognition target includes a lane, a vehicle, a two-wheeled vehicle, and a pedestrian, and
the second recognition target includes any of a display state of a traffic light, a road sign, a free space that is an area where there is no obstacle when an own vehicle moves, and a 3D sensing distance.

14. The image processing system according to claim 10, wherein when the predetermined condition is satisfied, the image processing system shifts to the degeneration mode, and a wiper on the window glass is stopped at a position not to obstruct an imaging field of view of the second imaging device.
